(19) United States
(12) Patent Application Publication
(10) Pub. No.: US 2026/0018733 A1
(43) Pub. Date: Jan. 15, 2026

(54) BATTERY MODULE AND BATTERY PACK

(71) Applicant: SK ON CO., LTD., Seoul (KR)

(72) Inventors: Chae Won NA, Daejeon (KR); Soo Geun PARK, Daejeon (KR); Gang U LEE, Daejeon (KR)

(21) Appl. No.: 19/250,080

(22) Filed: Jun. 26, 2025

(30) Foreign Application Priority Data
Jul. 9, 2024 (KR) 10-2024-0090056

(51) Int. Cl. H01M 50/293; H01M 50/358; H01M 50/383

(52) U.S. Cl. CPC H01M 50/293; H01M 50/358; H01M 50/383

(57) ABSTRACT

A battery module includes a lower frame including a plurality of accommodation spaces and a partition partitioning the plurality of accommodation spaces, at least one battery cell accommodated in each of the plurality of accommodation spaces, an upper cover disposed above the plurality of accommodation spaces and including a primary vent hole, a primary barrier disposed on one surface of the upper cover and including a porous structure, and a secondary barrier disposed on one surface of the primary barrier and including a secondary vent hole. The primary vent hole and the secondary vent hole are disposed to be offset from each other.

### CROSS-REFERENCE TO RELATED APPLICATION(S)

This patent document claims the priority and benefits of Korean Patent Application No. 10-2024-0090056 filed on Jul. 9, 2024, the disclosure of which is incorporated herein by reference in its entirety.

### TECHNICAL FIELD

The disclosure and implementations disclosed in this patent document generally relate to a battery module and a battery pack.

### BACKGROUND

Secondary batteries are one type of energy storage device that may be charged and discharged. Secondary batteries are widely used in various means that use electricity as a power source. For example, secondary batteries are used as energy storage devices in various means ranging from small devices such as mobile phones, laptops, and tablets to large devices such as vehicles and aircraft. In detail, secondary batteries have been actively explored as a vehicular power source recently.

Secondary batteries may be classified into lead-acid batteries, nickel-cadmium batteries, nickel-hydrogen batteries, lithium-ion batteries and the like depending on the material of the electrode or the like. Each type of secondary battery may be appropriately selected depending on the design capacity, usage environment, or the like. Alternatively, the secondary battery may be an all-solid-state battery that uses a solid electrolyte instead of a liquid electrolyte. Lithium-ion batteries may implement relatively high voltage and capacity compared to other types of secondary batteries. Accordingly, lithium-ion batteries are widely used in fields that require high-density energy storage devices such as vehicle battery packs.

Secondary batteries such as lithium-ion batteries may include a cathode, an anode, a separator, an electrolyte, and the like. The cathode and the anode are disposed with a separator of an insulating material therebetween, and charging or discharging thereof may be performed by the movement of ions through the electrolyte.

Secondary batteries are manufactured as flexible pouch-type battery cells or rigid prismatic or cylindrical can-type battery cells.

Multiple battery cells may be disposed inside a module housing to form a battery module, and multiple battery modules may be disposed inside a pack housing to form a battery pack.

In addition, recently, the formation of a battery module is omitted, and the Cell to Pack (CTP) method is used in which the battery cells are directly integrated into the battery pack and the battery pack is connected to the main body frame.

Meanwhile, when thermal propagation occurs in the battery module, a re-entering phenomenon may occur in which gas, flame, or foreign substances discharged through the vent hole collide with an external component and then re-enter the inside of the battery module.

### SUMMARY

The present disclosure can be implemented in some embodiments to prevent a re-entering phenomenon.

According to an aspect of the present disclosure, thermal propagation may be delayed.

The battery pack of the present disclosure may be widely applied in green technology fields such as electric vehicles, battery charging stations, and solar power generation and wind power generation using batteries. In addition, the battery pack of the present disclosure may be used in eco-friendly electric vehicles, hybrid vehicles, and the like to prevent climate change by suppressing air pollution and greenhouse gas emissions.

In some embodiments of the present disclosure, a battery module includes a lower frame including a plurality of accommodation spaces and a partition partitioning the plurality of accommodation spaces; at least one battery cell accommodated in each of the plurality of accommodation spaces; an upper cover disposed above the plurality of accommodation spaces and including a primary vent hole; a primary barrier disposed on one surface of the upper cover and including a porous structure; and a secondary barrier disposed on one surface of the primary barrier and including a secondary vent hole. The primary vent hole and the secondary vent hole are disposed to be offset from each other.

In an embodiment, the primary vent hole and the secondary vent hole may be disposed so as not to face each other in a first direction, perpendicular to the upper cover.

In an embodiment, the primary vent hole and the secondary vent hole may be disposed so as not to overlap each other in a first direction, perpendicular to the upper cover.

In an embodiment, the partition may be disposed so as not to overlap the primary vent hole in a first direction, perpendicular to the upper cover.

In an embodiment, the partition may be disposed in parallel with the at least one battery cell.

In an embodiment, the partition may be disposed to be perpendicular to the upper cover.

In an embodiment, the partition may be disposed to face an area located between a plurality of the primary vent holes among areas of the upper cover.

In an embodiment, the primary barrier may include a metallic material.

In an embodiment, the primary barrier may include at least one of metal foam, metal mesh, steel wool wire, or a porous steel sheet.

In an embodiment, the secondary barrier may include a metallic material.

In an embodiment, the secondary barrier may be formed of a metallic shielding film.

In an embodiment, the primary vent hole and the secondary vent hole may be configured to discharge gas, flame or foreign matter generated in at least one of the plurality of accommodation spaces externally.

In an embodiment, the primary vent hole may be disposed to be offset from the secondary vent hole to block gas, flame or foreign matter flowing in through the secondary vent hole from an outside of the secondary barrier.

In some embodiments of the present disclosure, a battery pack includes a plurality of battery modules; and a pack frame accommodating the plurality of battery modules. Each of the plurality of battery modules includes a lower frame including a plurality of accommodation spaces and a partition partitioning the plurality of accommodation spaces; at least one battery cell accommodated in each of the plurality of accommodation spaces; an upper cover disposed above the plurality of accommodation spaces and including a primary vent hole; a primary barrier disposed on one surface of the upper cover and including a porous structure; and a secondary barrier disposed on one surface of the primary barrier and including a secondary vent hole. The primary vent hole and the secondary vent hole are disposed to be offset from each other.

In an embodiment, the pack frame may include a pack cover disposed above the secondary barrier.

### BRIEF DESCRIPTION OF DRAWINGS

Certain aspects, features, and advantages of the present disclosure are illustrated by the following detailed description with reference to the accompanying drawings.

FIG. 1 is a perspective view of a battery module according to an embodiment.

FIG. 2 is an exploded perspective view of a battery module according to an embodiment.

FIG. 3 is a plan view illustrating a portion of a battery module according to an embodiment.

FIG. 4 is a cross-sectional view illustrating a portion of a battery module according to an embodiment.

FIG. 5 is an exploded perspective view of a battery pack according to an embodiment.

FIG. 6 is a cross-sectional view illustrating a portion of a battery pack according to an embodiment.

FIG. 7 is a cross-sectional view illustrating a portion of a battery pack according to an embodiment.

### DETAILED DESCRIPTION

Features of the present disclosure disclosed in this patent document are described by example embodiments with reference to the accompanying drawings.

Hereinafter, embodiments of the present disclosure will be described with reference to the attached drawings.

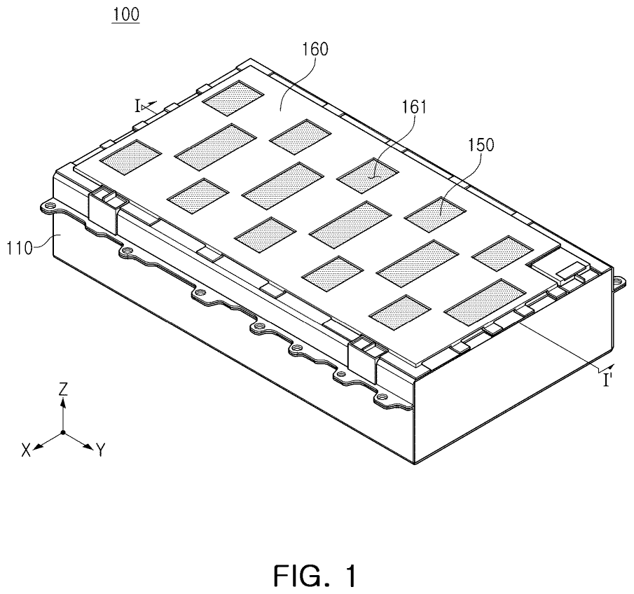

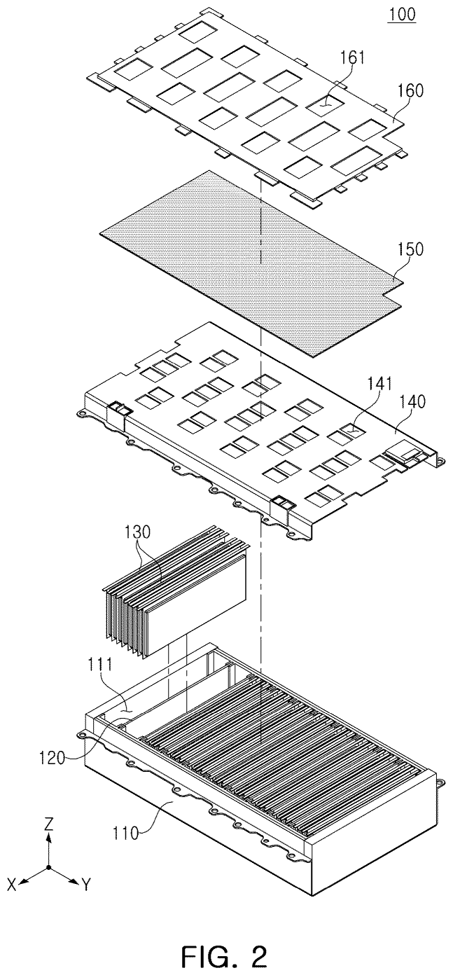

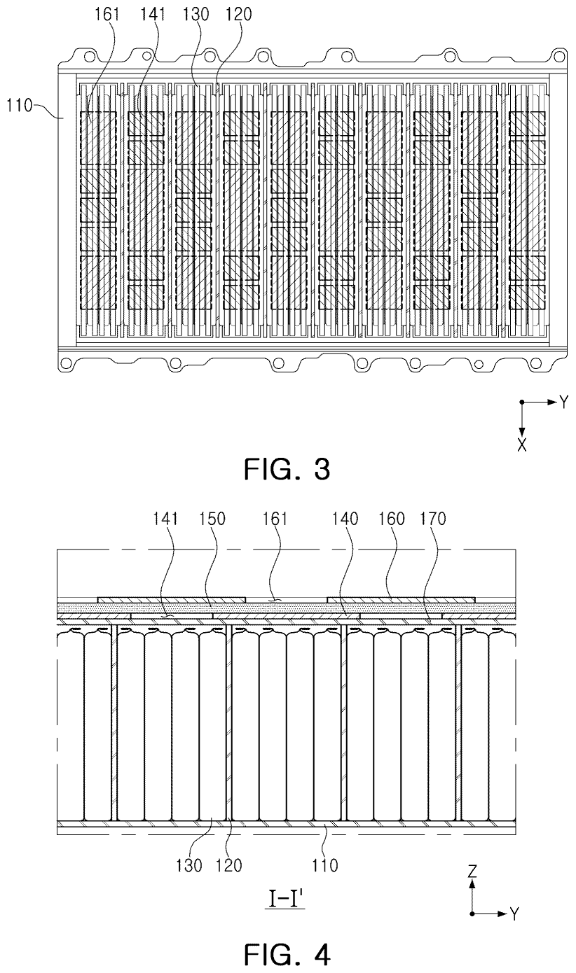

FIG. 1 is a perspective view of a battery module 100 according to an embodiment, FIG. 2 is an exploded perspective view of a battery module 100 according to an embodiment, FIG. 3 is a plan view illustrating a portion of a battery module 100 according to an embodiment, and FIG. 4 is a cross-sectional view illustrating a portion of a battery module 100 according to an embodiment.

Referring to FIGS. 1 to 4, the battery module 100 may include a lower frame 110, at least one battery cell 130, an upper cover 140, a primary barrier 150, and a secondary barrier 160.

The lower frame 110 is a frame located in a lower portion of the battery module 100 and may include a plurality of accommodation spaces 111. Each of the plurality of accommodation spaces 111 may accommodate at least one battery cell 130. Each of the plurality of accommodation spaces 111 may include a space sufficient to accommodate at least one battery cell 130. The plurality of accommodation spaces 111 may be formed in various shapes, and may include, for example, a shape similar to a rectangular parallelepiped shape.

The lower frame 110 may include a partition 120 that partitions the plurality of accommodation spaces 111. The lower frame 110 includes an accommodation space, and the partition 120 may partition the accommodation space into a plurality of pieces. The partition 120 may be disposed to be erected on the bottom of the lower frame 110, and both ends of the partition 120 may be connected to the side walls of the lower frame 110. The plurality of accommodation spaces 111 may be respectively isolated by the partition 120.

The partition 120 may be disposed so as not to overlap the primary vent hole 141 in a first direction that is perpendicular to the upper cover 140. In detail, when viewed in the first direction, the primary vent hole 141 and the partition 120 may not overlap each other. For example, the primary vent hole 141 may be located only on one accommodation space and may not be located on two adjacent accommodation spaces. Therefore, when a fire occurs in one accommodation space, the fire may be prevented from spreading to the adjacent accommodation space through the primary vent hole 141.

In addition, the partition 120 may be disposed in parallel with at least one battery cell 130. For example, when the battery cell 130 is a pouch-type secondary battery, one surface of the partition 120 may be disposed to face the side surface of the battery cell 130. The partition 120 may be disposed to be perpendicular to the upper cover 140. In detail, the partition 120 may be disposed to be erected in the first direction.

The partition 120 may be disposed to face an area located between a plurality of primary vent holes 141 among the areas of the upper cover 140. For example, the primary vent hole 141 may be disposed to be spaced apart from another adjacent primary vent hole 141 by a certain distance. At this time, the area between the primary vent holes 141 and the partition 120 may face each other. The upper portion of the partition 120 may be in contact with the upper cover 140, or a Flexible Printed Circuit Board (FPCB) frame 170 and the like may be disposed therebetween. However, the configuration of the Flexible Printed Circuit Board (FPCB) frame 170 or the like is not an essential configuration and may be omitted as needed.

The battery cell 130 may be formed of a lithium secondary battery, but is not limited thereto. For example, the battery cell 130 may be formed of various types of secondary batteries such as a nickel-cadmium battery, a nickel-metal hydride battery, and a nickel-hydrogen battery. The battery cell 130 may be formed of a pouch-type secondary battery. Hereinafter, a case in which a pouch-type secondary battery is used as the battery cell 130 will be described as an example. However, the present disclosure does not exclude the use of a can-type secondary battery such as a prismatic secondary battery or a cylindrical secondary battery as the battery cell 130.

At least one battery cell 130 may be accommodated in each of the plurality of accommodation spaces 111. When there are multiple battery cells 130, the plurality of battery cells 130 may be arranged in a certain direction (X) and may be stacked. Each battery cell 130 may output or store electrical energy.

The upper cover 140 may be a cover disposed on the upper portion of the battery module 100. The upper cover 140 may cover the upper portion of the battery module 100. For example, the upper cover 140 may include a plate shape and may cover the upper portions of a plurality of accommodation spaces 111.

The upper cover 140 may include a primary vent hole 141. The primary vent hole 141 may be a hole that discharges gas, flame, for foreign substances (hereinafter, gas) generated within the battery module 100 to the outside. For example, when a fire occurs in at least one battery cell 130 accommodated in a plurality of accommodation spaces 111, the pressure within the plurality of accommodation spaces 111 may increase. At this time, the gas or the like may be discharged to the outside through the primary vent hole 141 located at the upper portion.

The primary barrier 150 may be disposed on one surface of the upper cover 140. The primary barrier 150 may be disposed on the upper surface of the upper cover 140. The primary barrier 150 may cover the upper cover 140. For example, the primary barrier 150 includes a plate shape and may cover the upper portion of the upper cover 140. In detail, the primary barrier 150 may be disposed to cover the primary vent hole 141 in the upper portion of the upper cover 140. At this time, the primary vent holes 141 may be distributed in the upper cover 140 and may cover all of the primary vent holes 141.

The primary barrier 150 may include a porous structure. Fire or gas generated inside the battery module 100 may pass through the primary vent hole 141 and then be discharged to the outside through the porous structure of the primary barrier 150. At this time, the pressure may be reduced, the discharge speed may be slowed, or included foreign substances may be filtered due to the porous structure of the primary barrier 150. The primary barrier 150 may include a material having heat resistance or fire resistance. For example, the primary barrier 150 may include a metallic material. The metallic material may include steel, aluminum, nickel, or the like. The primary barrier 150 may include various forms having a porous structure. For example, the primary barrier 150 may include at least one of metal foam, metal mesh, steel wool wire, or porous steel sheet. The metal foam, metal mesh, and steel wool wire may have a porous structure or shape.

The secondary barrier 160 may be disposed on one surface of the primary barrier 150. The secondary barrier 160 may be disposed on the upper surface of the primary barrier 150. The secondary barrier 160 may cover the primary barrier 150. The secondary barrier 160 may be formed to include an area equal to or larger than that of the primary barrier 150 to cover the primary barrier 150. The secondary barrier 160 may include a plate shape to cover the primary barrier 150.

The secondary barrier 160 may include a secondary vent hole 161. The secondary vent hole 161 may be a hole that discharges gas and the like generated inside the battery module 100 to the outside. In detail, the gas may first pass through the primary vent hole 141, then pass through the porous structure of the primary barrier 150, and then be discharged to the outside through the secondary vent hole 161.

At this time, the primary vent hole 141 and the secondary vent hole 161 may be disposed in an alternating manner. Disposing in an alternating manner may mean that the primary vent hole 141 and the secondary vent hole 161 are not disposed side by side or that centers thereof do not coincide. In detail, the secondary vent hole 161 may be disposed in an alternating manner with the primary vent hole 141 so that the gas discharged through the primary vent hole 141 cannot be discharged while maintaining the same direction of movement.

The primary vent hole 141 and the secondary vent hole 161 may be disposed so as not to face each other in the first direction. For example, when the secondary vent hole 161 is viewed from the first direction, the primary vent hole 141 may not be visible. In detail, the primary vent hole 141 and the secondary vent hole 161 may not overlap each other in the first direction. In detail, the primary vent hole 141 and the secondary vent hole 161 may be disposed so as not to overlap each other in the first direction, which is a direction perpendicular to the upper cover 140. In detail, the area of the primary vent hole 141 and the area of the secondary vent hole 161 may not overlap each other in the first direction.

The primary vent hole 141 and the secondary vent hole 161 may be configured to discharge gas generated in at least one of the plurality of accommodation spaces 111 to the outside. As the primary vent hole 141 and the secondary vent hole 161 are disposed alternately, at least one path change occurs during the process of gas discharge, thereby delaying the thermal propagation situation. In detail, even if the gas passes through the primary vent hole 141, the path may be changed or delayed by the porous structure of the primary barrier 150, and after the path change, the gas may be discharged to the outside through the secondary vent hole 161.

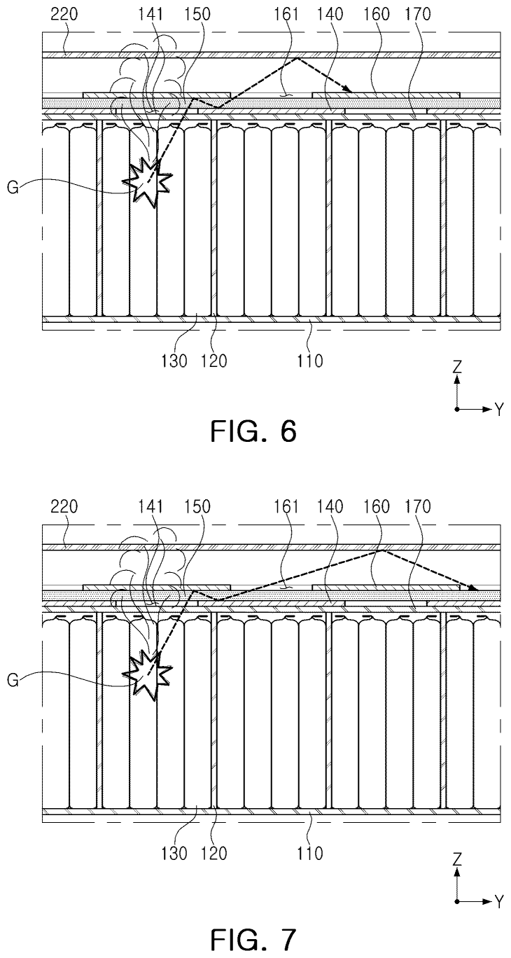

In addition, the primary vent hole 141 may be disposed alternately with the secondary vent hole 161 to block gas flowing in through the secondary vent hole 161 from the outside of the secondary barrier 160. The gas discharged to the outside of the battery module 100 may return to the battery module 100 after hitting an external component. However, even if the returned gas passes through the secondary vent hole 161, the gas may not easily pass through the primary vent hole 141 because it should pass through the porous structure of the primary barrier 150 again. In addition, the primary vent hole 141 is disposed to be offset from the secondary vent hole 161, so that the inflowing gas may have difficulty passing through the primary vent hole 141. The path of this gas will be described again with reference to FIGS. 6 and 7 below.

The secondary barrier 160 may include a material having heat resistance or fire resistance. For example, the secondary barrier 160 may include a metallic material. The metallic material may include steel, aluminum, nickel, and the like. The secondary barrier 160 may be formed of a metallic shielding film. For example, the secondary barrier 160 may be a metallic plate having a shielding property with a secondary vent hole 161 perforated therein. Therefore, gas and the like may not pass through other parts of the secondary barrier 160 except for the secondary vent hole 161.

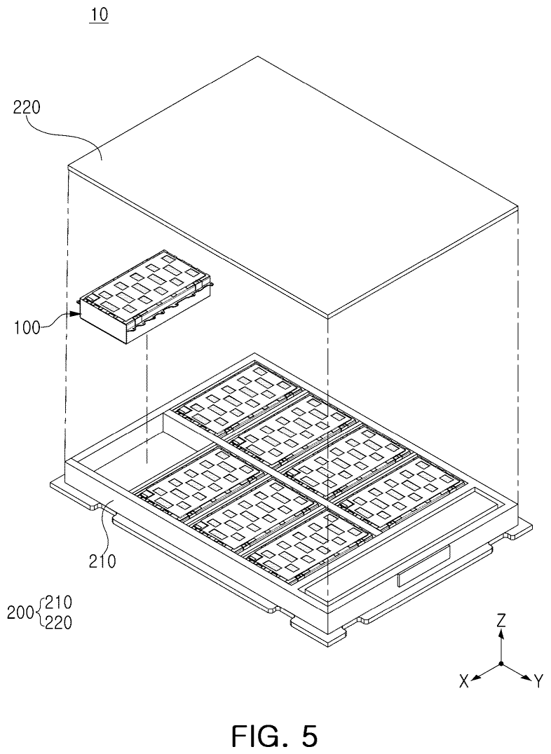

FIG. 5 is an exploded perspective view of a battery pack 10 according to an embodiment, FIG. 6 is a cross-sectional view illustrating a portion of a battery pack 10 according to an embodiment, and FIG. 7 is a cross-sectional view illustrating a portion of a battery pack 10 according to an embodiment.

Referring to FIGS. 5 to 7, the battery pack 10 may include a plurality of battery modules 100 and a pack frame 200.

The plurality of battery modules 100 may be an assembly in which a plurality of battery modules 100 are assembled. Each battery module 100 may be any one of the battery modules 100 described in FIGS. 1 to 4.

The pack frame 200 may accommodate a plurality of battery modules 100. For example, the pack frame 200 may include a base frame 210 located at a lower portion and a pack cover 220 covering the upper portion thereof. The base frame 210 include may an accommodation space that accommodates the battery module 100. The accommodation space is configured in multiple units, and a battery module 100 may be accommodated in each accommodation space.

The pack cover 220 may be disposed above the secondary barrier 160. For example, when a plurality of battery modules 100 are accommodated in the accommodation spaces of the base frame 210, the pack cover 220 may be combined with the base frame 210. At this time, the pack cover 220 includes a plate shape, and the secondary barrier 160 of each battery module 100 may face the pack cover 220. For example, the pack cover 220 may be disposed on the plurality of upper covers 140. The pack cover 220 may be disposed on the upper parts of the primary barrier 150 and the secondary barrier 160. The pack cover 220 may be disposed on one surface of the secondary barrier 160 to cover the upper surface of the secondary barrier 160.

The pack cover 220 may be an external component of the battery module 100 described in FIGS. 1 to 4. Accordingly, the gas (G) discharged from the battery module 100 may return to the battery module 100 after hitting the pack cover 220. This phenomenon is called re-entering, and the primary vent hole 141 and the secondary vent hole 161 disposed alternately may prevent the re-entering phenomenon.

FIGS. 6 and 7 illustrate a thermal propagation situation. The movement path of gas (G) generated from the battery cell 130 is indicated by a dotted line.

Referring to FIG. 6, gas (G) may be discharged through the primary vent hole 141. Then, gas (G) may pass through the porous structure of the primary barrier 150. Then, gas (G) may hit the secondary barrier 160 and pass through the porous structure of the primary barrier 150 again. Then, gas (G) may hit the upper portion of the upper cover 140 and pass through the porous structure of the primary barrier 150 again. Then, gas (G) may be discharged through the secondary vent hole 161 and return by hitting an external component or pack cover 220. Then, the gas (G) may hit the upper surface of the secondary barrier 160.

Or, referring to FIG. 7, the gas (G) that has returned after hitting the external configuration or pack cover 220 passes through the secondary vent hole 161 and then hits the primary barrier 150.

The gas (G) may decrease in speed and temperature through the above-mentioned multiple processes such as path switching, collision, filtering, and the like. Therefore, the structure of the battery module 100 or battery pack 10 of the present disclosure may delay thermal propagation and prevent the re-entering phenomenon.

As set forth above, according to an embodiment, a re-entering phenomenon may be prevented.

According to an embodiment, thermal propagation may be delayed.

Only specific examples of implementations of certain embodiments are described. Variations, improvements and enhancements of the disclosed embodiments and other embodiments may be made based on the disclosure of this patent document.

What is claimed is:

1. A battery module comprising:
a lower frame including a plurality of accommodation spaces and a partition partitioning the plurality of accommodation spaces;
at least one battery cell accommodated in each of the plurality of accommodation spaces;
an upper cover disposed above the plurality of accommodation spaces and including a primary vent hole;
a primary barrier disposed on one surface of the upper cover and including a porous structure; and
a secondary barrier disposed on one surface of the primary barrier and including a secondary vent hole,
wherein the primary vent hole and the secondary vent hole are disposed to be offset from each other.

2. The battery module of claim 1, wherein the primary vent hole and the secondary vent hole are disposed so as not to face each other in a first direction, perpendicular to the upper cover.

3. The battery module of claim 1, wherein the primary vent hole and the secondary vent hole are disposed so as not to overlap each other in a first direction, perpendicular to the upper cover.

4. The battery module of claim 1, wherein the partition is disposed so as not to overlap the primary vent hole in a first direction, perpendicular to the upper cover.

5. The battery module of claim 1, wherein the partition is disposed in parallel with the at least one battery cell.

6. The battery module of claim 1, wherein the partition is disposed to be perpendicular to the upper cover.

7. The battery module of claim 1, wherein the partition is disposed to face an area located between a plurality of the primary vent holes among areas of the upper cover.

8. The battery module of claim 1, wherein the primary barrier includes a metallic material.

9. The battery module of claim 1, wherein the primary barrier includes at least one of metal foam, metal mesh, steel wool wire, or a porous steel sheet.

10. The battery module of claim 1, wherein the secondary barrier includes a metallic material.

11. The battery module of claim 1, wherein the secondary barrier is formed of a metallic shielding film.

12. The battery module of claim 1, wherein the primary vent hole and the secondary vent hole are configured to discharge gas, flame or foreign matter generated in at least one of the plurality of accommodation spaces externally.

13. The battery module of claim 1, wherein the primary vent hole is disposed to be offset from the secondary vent hole to block gas, flame or foreign matter flowing in through the secondary vent hole from an outside of the secondary barrier.

14. A battery pack comprising:
a plurality of battery modules; and
a pack frame accommodating the plurality of battery modules,
wherein each of the plurality of battery modules includes,
a lower frame including a plurality of accommodation spaces and a partition partitioning the plurality of accommodation spaces;
at least one battery cell accommodated in each of the plurality of accommodation spaces;
an upper cover disposed above the plurality of accommodation spaces and including a primary vent hole;
a primary barrier disposed on one surface of the upper cover and including a porous structure; and
a secondary barrier disposed on one surface of the primary barrier and including a secondary vent hole,
wherein the primary vent hole and the secondary vent hole are disposed to be offset from each other.

15. The battery pack of claim 14, wherein the pack frame includes a pack cover disposed above the secondary barrier.
